(19) United States
(12) Patent Application Publication
(10) Pub. No.: US 2009/0328026 A1
(43) Pub. Date: Dec. 31, 2009

(54) UPDATE SYSTEM, PROGRAM EXECUTION DEVICE, AND COMPUTER PROGRAM

(75) Inventors: Hiroyuki Yamashita, Takamatsu (JP); Takahiro Fujino, Takamatsu (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/556,168

(22) Filed: Sep. 9, 2009

Related U.S. Application Data
(63) Continuation of application No. PCT/JP2007/055767, filed on Mar. 20, 2007.

(51) Int. Cl. G06F 9/44

(52) U.S. Cl. 717/170; 717/168

(57) ABSTRACT

A version table (11a) recording therein information indicative of an execution program (22a) and version number information indicative of a version number of a version of the updatable execution program (22a) in association with each other is provided in a central device (1). In a terminal device (2), an instruction accepted for the execution program (22a) is detected, the version number of the version of the execution program (22a) as the target of the instruction is detected, the version number indicated by the version number information of the execution program (22a) is read from the version table (11a), and the execution program (22a) is updated when it is determined that the detected version number and the read version number are different from each other.

This application is a continuation, filed under 35 U.S.C. §111(a), of PCT International Application No. PCT/JP2007/055767 which has an international filing date of Mar. 20, 2007, and designated the United States of America.

### FIELD

The embodiment discussed herein relates to an update system for updating an execution program capable of executing an accepted instruction such as an application program and the like, a program execution device used in the update system, and a computer program for implementing the program execution device. The embodiment discussed herein preferably relates to an update system, a program execution device, and a computer program which prevent the omission of an update and efficiently perform the update.

### BACKGROUND

An execution program executed in a computer such as an application program and the like is successively improved and a version reflecting the improved content therein is provided to a user. The user preferably uses the improved execution program by upgrading (updating) the execution program. In a corporate system provided with a plurality of terminal devices, the upgrade of the execution program is required for each of the terminal devices.

Consequently, there is a method in which, every time a new version is released, a program for the upgrade is sent to all terminal devices through a multi-address transmission to prompt the individual users operating the terminal devices to perform the upgrade.

In addition, there is a method in which the terminal device which has received the operation by the user activates a browser and accesses a web site for delivering information on the upgrade to obtain the information on the upgrade as a cookie file managed by the browser (e.g., Patent Document 1).

[Patent Document 1] Japanese Laid-Open Patent Publication No. H11 (1999)-065828

### SUMMARY

However, there is a problem that it is not easy for the individual users operating their respective terminal devices to constantly monitor the status of the release of the new version and update the execution program every time the new version is delivered in terms of various aspects such as a workload and the like. There is also a problem that, even when the program for the upgrade is sent to each of the terminal devices through the multi-address transmission, not all of the users operating the terminal devices perform the upgrade. In addition, not all of the terminal devices have the same execution program. Accordingly, there is a problem that the multi-address transmission of the program for the upgrade unnecessarily increases a transmission load and a processing load, and burdens a storage area of the terminal device. Further, even in the terminal device having the execution program as the target of the upgrade, the following problem is encountered. That is, when the upgrade for a given function is performed in the execution program having a plurality of functions, because the upgrade is not necessary for the user who does not use the function, the multi-address transmission of the program for the upgrade unnecessarily increases the communication load and the processing load, and burdens the storage area of the terminal device.

Because the user needs to access the web site for delivering the information on the upgrade, the user may bear the burden of substantially monitoring the status of the release of the version.

Thus, the update of the execution program involves various problems, and the neglect of the problems may not only prevent the use of effective functions but also cause various system failures.

An update system according to a first aspect, for updating an execution program capable of executing an accepted instruction, includes: a part detecting the instruction accepted for the execution program; a part determining whether or not an update of the execution program is necessary, before the execution program executes the detected instruction; and a part updating the execution program when it is determined that the update of the execution program is necessary.

An update system according to a second aspect, for updating an execution program capable of executing an accepted instruction, includes: a version table recording version number information indicative of a version number of a version of an updatable execution program in association with program information indicative of the execution program; an instruction detection part detecting the instruction accepted for the execution program; a detection part detecting the version number of the version of the execution program as a target of the accepted instruction; a read part reading the version number information in correspondence to the execution program as the target of the accepted instruction from the version table; a comparison part comparing the detected version number of the version with the version number of the version read from the version table; and an update part updating the execution program when it is determined that the version numbers are different from each other by the comparison.

An update system according to a third aspect is configured in the second aspect, wherein the version table is configured to record instruction information indicative of the instruction in association with the program information, and the read part is configured to read the version number information associated with the accepted instruction and the execution program as the target of the instruction.

An update system according to a fourth aspect is configured in the third aspect, wherein the version table is configured to record the instruction information indicative of an activation instruction to the execution program and/or the instruction information indicative of a given operation instruction to an activated execution program.

An update system according to a fifth aspect is configured in any one of the second to fourth aspects, wherein the version table is configured to record urgency degree information indicative of an urgency degree in association with the program information, and the update part is configured to determine whether or not an acceptance of an instruction indicative of approval or disapproval of the update is necessary in accordance with the urgency degree indicated by the urgency degree information in correspondence to the program information of the execution program as the target of the update.

An update system according to a sixth aspect is configured in the fifth aspect, further including: a part detecting an abnormal termination of the execution program; and a part modifying the urgency degree information recorded in the version table in association with the program information indicative of the execution program from which the abnormal termination is detected.

An update system according to a seventh aspect is configured in any one of the second to sixth aspects, further including: an execution restriction table recording condition information indicative of the version number and/or time as a condition for the execution of the instruction in association with the program information; and a part determining whether the execution of the instruction is approved or disapproved on a basis of the condition for the execution program as the target of the accepted instruction by referring to the execution restriction table.

An update system according to an eighth aspect is configured in any one of the second to seventh aspects, further including: a terminal device having the execution program, the instruction detection part, the detection part, the read part, the comparison part, and the update part; and a central device having the version table.

A program execution device according to a ninth aspect, for updating an execution program capable of executing an accepted instruction, includes: a part detecting the instruction accepted for the execution program; a part determining whether or not an update of the execution program is necessary before the execution program executes the detected instruction; and a part updating the execution program when it is determined that the update of the execution program is necessary.

A computer program according to a tenth aspect, for causing a computer having an execution program capable of executing an accepted instruction to update the execution program, the computer program causing the computer to execute the steps of: detecting the instruction accepted for the execution program; determining whether or not an update of the execution program is necessary before the execution program executes the detected instruction; and updating the execution program when it is determined that the update of the execution program is necessary.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a conceptual view illustrating an example of a configuration of an update system of the invention;

FIG. 2 is a block diagram illustrating an example of a configuration of each of devices included in the update system of the invention;

FIG. 3 is an explanatory view illustrating an example of a recorded content of a version table included in a central device used in the update system of the invention;

FIG. 4 is an explanatory view illustrating an example of a recorded content of an execution restriction table included in the central device used in the update system of the invention;

FIG. 5 is a flow chart illustrating an example of update monitoring processing of a terminal device used in the update system of the invention; and

FIG. 6 is a flow chart illustrating an example of processing at the time of an abnormal termination of the terminal device used in the update system of the invention.

### DESCRIPTION OF EMBODIMENTS

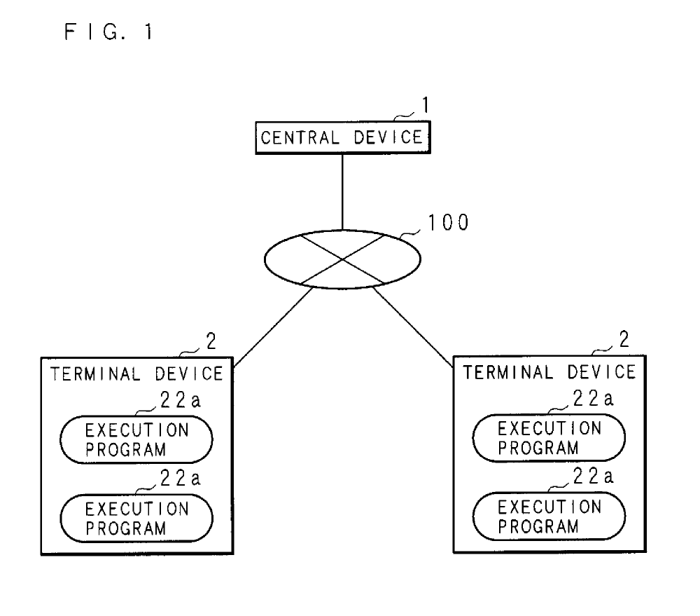

The invention will be described hereinbelow in detail on the basis of the drawings illustrating the embodiments thereof. FIG. 1 is a conceptual view illustrating an example of a configuration of an update system of the invention. 1 in FIG. 1 denotes a central device using a computer such as a sever computer or the like, and the central device 1 is connected to a communication network 100 such as a LAN or the like. To the communication network 100, terminal devices 2, 2, . . . each using a computer such as a client computer or the like are connected. In the individual terminal devices 2, 2, . . . , various execution programs 22a, 22a, . . . such as various application programs are recorded. Versions of the individual execution programs 22a, 22a, . . . are updated for various purposes such as modification of a malfunction, addition of functions, an improvement, and the like.

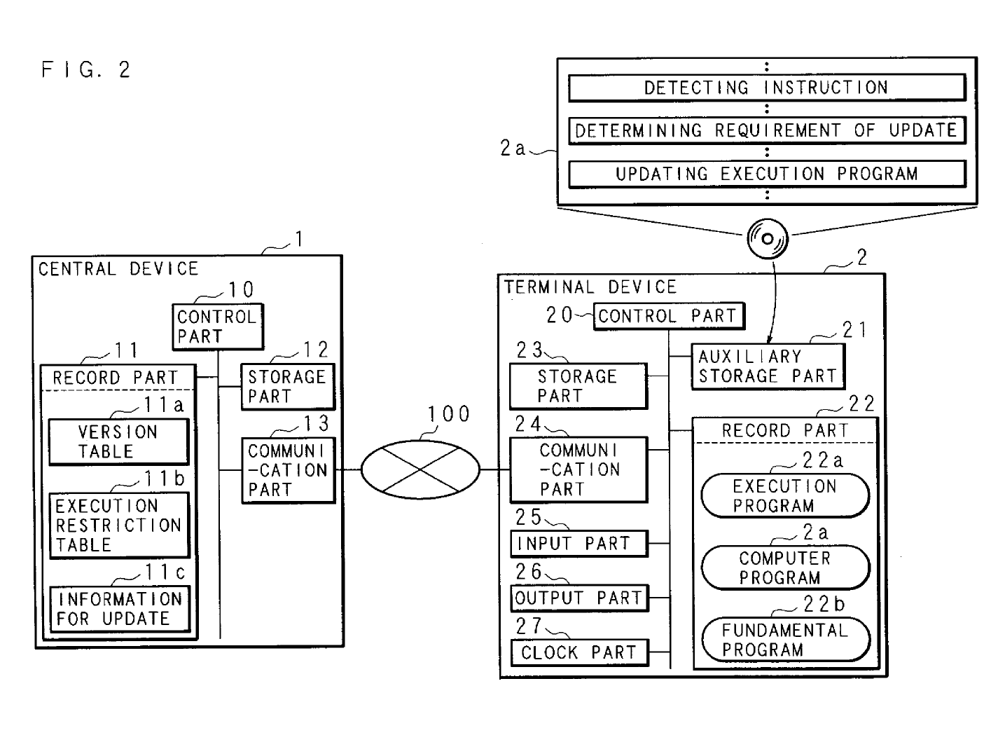

FIG. 2 is a block diagram illustrating an example of a configuration of each of devices included in the update system of the invention. The central device 1 includes a control part 10 controlling the entire device such as a CPU or the like, a record part 11 recording therein various information such as a hard disk or the like, a storage part 12 temporarily storing information such as a RAM or the like, and a communication part 13 allowing connection to the communication network 100 such as a LAN board or the like.

In the record part 11, a version table 11a recording therein information related to the version of the execution program 22a executed in the terminal device 2, and an execution restriction table 11b recording therein conditions related to the execution of the execution program 22a executed in the terminal device 2 are recorded. In addition, in the record part 11, information for update 11c, 11c, . . . required for the update (upgrade) of the versions of the respective execution programs 22a, 22a, . . . recorded in the terminal devices 2, 2, . . . such as a program and data is also recorded.

The terminal device 2 includes a control part 20 controlling the entire device such as the CPU or the like, an auxiliary storage part 21, such as a CD-ROM drive or the like, reading various information from a recording medium such as a CD-ROM or the like recording therein various information such as a computer program 2a of the invention and data, a record part 22 recording therein the various information read by the auxiliary storage part 21 such as the hard disk or the like, and a storage part 23 temporarily storing information such as the RAM or the like. The computer program 2a of the invention recorded in the record part 22 is stored in the storage part 23 and executed with the control by the control part 20, whereby the client computer operates as the terminal device (program execution device) 2 of the invention.

Further, the terminal device 2 includes a communication part 24 allowing the connection to the communication network 100 such as the LAN or the like, an input part 25 accepting inputs on the basis of the operation by the user as a man-machine interface such as a mouse, a keyboard, or the like, an output part 26 performing output to the user as the man-machine interface, and a clock part 27 indicating a date, a day of the week, and time.

In the record part 22, not only the computer program 2a of the invention but also various execution programs 22a, 22a, . . . executed on an operating system (OS) 22b such as various application programs are recorded. At the time of boot of the terminal device 2, the operating system 22b is firstly booted up and, then, the computer program 2a of the invention is activated as a resident program on the operating system 22b. Then, the execution program 22a is activated on the operating system 22b. The user inputs various instructions such as an instruction for activating the execution program 22a, an instruction for causing the activated execution program 22a to execute given processing, and the like from the input part 25, and the inputted instructions are passed to the execution program 22a from the operating system 22b. The computer program 2a of the invention monitors the various instructions to be accepted by the execution program 22a from the operating system 22b, and executes various processing described later on the basis of the various instructions.

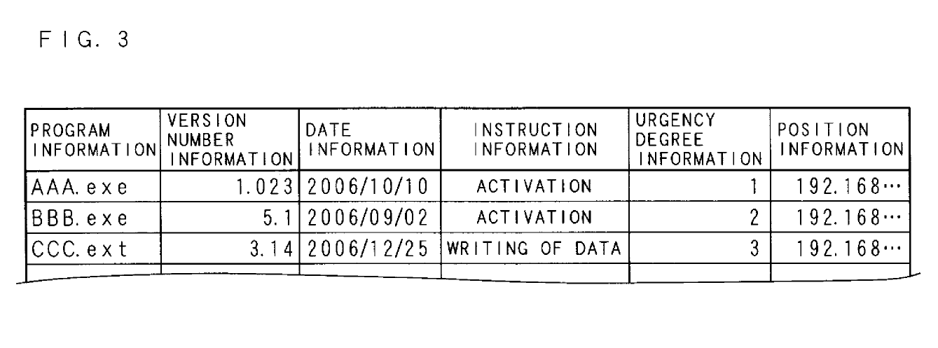

FIG. 3 is an explanatory view illustrating an example of the recorded content of the version table 11a included in the central device 1 used in the update system of the invention. In the version table 11a, program information indicative of the execution program 22a such as a name or the like, version number information indicative of a version number of the latest version of the updatable execution program 22a, date information indicative of a date of the release of the latest version, instruction information indicative of an instruction to the execution program 22a, urgency degree information indicative of an urgency degree, and position information indicative of a device and/or a position recording the information for update 11c such as a URL, an IP address, or the like are recorded on a record-by-record basis in association with one another. The instruction indicated by the instruction information is an instruction such as an activation instruction to the execution program 22a, a given operation instruction to the activated execution program 22a, or the like. The given operation instruction denotes, e.g., an instruction involving the update such as writing of data or the like and an instruction for executing the communication with another device. The urgency degree indicated by the urgency degree information is represented by a number, “1” indicative of the highest urgency degree denotes that the update is forcibly executed with the highest priority, and “2” and “3” denote the acceptance of the instruction indicative of approval or disapproval of the update, i.e., that the determination by the user is required. At the urgency degree “2”, when the instruction indicative of approval of the update from the user is not accepted, the priority is given to the normal processing of the execution program 22a under execution. However, the update of the execution program 22a is forcibly performed at the time of termination of the execution program 22a. At the urgency degree “3”, the update of the execution program 22a is not performed until the instruction indicative of approval of the update from the user is accepted. When the recorded position of the information for update 11c is preset at a given position in the central device 1, the record of the position information may be omitted.

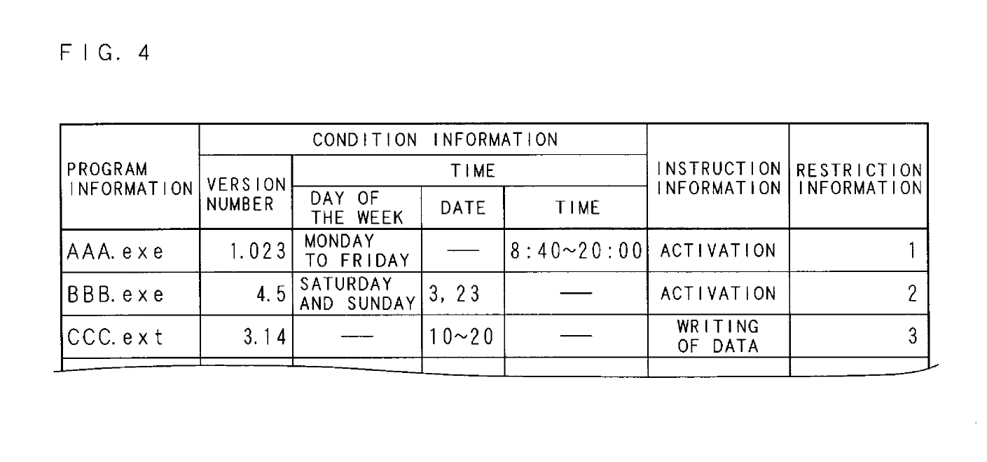

FIG. 4 is an explanatory view illustrating an example of a recorded content of the execution restriction table 11b included in the central device 1 used in the update system of the invention. In the execution restriction table 11b, the program information, the condition information indicative of conditions related to the restriction on the execution of the execution program 22a, the instruction information, and restriction information indicative of the content of the restriction on the execution are recorded on a record-by-record basis in association with one another. As the condition information, the version number and time are set and, as the time, a day of the week, a date, and time are set. The content of the restriction indicated by the restriction information is represented by a number. “1” denotes that the execution of the execution program 22a is approved, “2” denotes that the execution of the execution program 22a is disapproved, and “3” denotes that the monitoring of the execution program is not performed.

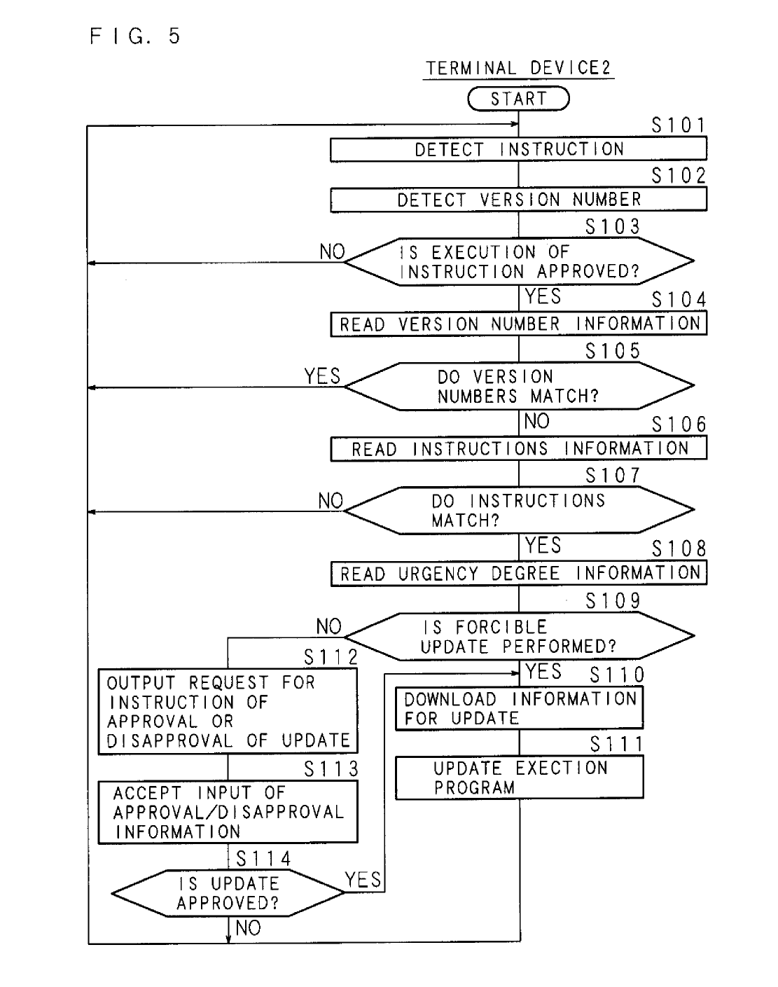

Next, a description will be given to the processing of each of the devices included in the update system of the invention. FIG. 5 is a flow chart illustrating an example of update monitoring processing of the terminal device 2 used in the update system of the invention. By the operation of booting the terminal device 2 performed by the user, the terminal device 2 is booted up. Then, the operating system 22b is booted up and, thereafter, the computer program 2a of the invention is activated as the resident program on the operating system 22b. Then, the user performs the operation of inputting various instructions such as the instruction for activating the execution program 22a, the instruction for causing the activated execution program 22a to execute given processing, and the like from the input part 25.

The terminal device 2 interprets the instruction accepted by the input part 25 in the operating system 22b with the control by the control part 20 executing the computer program 2a of the invention, and detects the instruction determined to be the instruction to the execution program 22a (S101). The computer program 2a of the invention is resident on the operating system 22b, and monitors the instruction for the operating system 22b to activate the execution program 22a and the instruction to be passed to the execution program 22a in an active state after the activation. The terminal device 2 executes subsequent processing when the terminal device 2 detects the instruction to the execution program 22a in the step S101.

The terminal device 2 detects the version number of the version of the execution program 22a as the target of the accepted instruction (targeted by the accepted instruction) with the control by the control part 20 (S102).

Then, the terminal device 2 accesses the central device 1 connected to the communication network 100 through the communication part 24 with the control by the control part 20, reads the condition information and the restriction information which are in correspondence to the execution program 22a as the target of the accepted instruction (targeted by the accepted instruction) and the accepted instruction from the execution restriction table 11b included in the central device 1, and determines whether or not the execution of the instruction is approved on the basis of the read condition information and restriction information (S103). As described by using FIG. 4, the condition information, the instruction information, and the restriction information are recorded in association with the program information in the execution restriction table 11b. In the step S103, a record in correspondence to the program information indicative of the execution program 22a as the target of the instruction (targeted by the instruction) and the instruction information indicative of the accepted instruction is read and, when the conditions related to the version number and time indicated as the condition information in the read record match the date, the day of the week, and time indicated by the clock part 27 and the version number detected in the step S102, it is determined whether or not the execution of the instruction is approved on the basis of the restriction information recorded in the read record. That is, when the restriction information of the record matching the conditions indicates that the execution is approved or that the monitoring is not performed, it is determined that the execution of the instruction is approved and, when the restriction information indicates that the execution is prohibited, it is determined that the execution of the instruction is disapproved. When a record in correspondence to the program information, the instruction information, and the condition information is not recorded, it is determined that the execution is approved.

In the step S103, when it is determined that the execution of the instruction is approved (S103: YES), the terminal device 2 accesses the central device 1 with the control by the control part 20 to read the version number information in correspondence to the execution program 22a as the target of the accepted instruction from the version table 11a included in the central device 1 (S104).

Subsequently, the terminal device 2 compares the version number of the version of the execution program 22a as the target of the accepted instruction with the version number of the version indicated by the version number information read from the version table 11a with the control by the control part 20 to determine whether or not the version numbers match each other (S105). In the step S105, when the version number of the execution program 22a as the target of the instruction matches the version number of the version table 11a, it is determined that the version of the execution program 22a as the target of the instruction is the latest version. When it is determined that the version numbers are different from each other, i.e., it is determined that the version number of the version table 11a is newer than that of the execution program 22a as the target of the instruction, it is determined that the version of the execution program 22a as the target of the instruction is not the latest version. In the step S105, when it is possible to detect the release date of the version of the execution program 22a as the target of the instruction, the detected date may be compared with the date indicated by the date information recorded in the version table 11a.

In the step S105, when it is determined that the version numbers match each other by the comparison, i.e., it is determined that the version of the execution program 22a as the target of the instruction is the latest version (S105: YES), the terminal device 2 returns to the step S101 with the control by the control part 20 to repeat the subsequent processing. That is, because the latest version is used, it is determined that the update is not necessary.

In the step S105, when it is determined that the version numbers are different from each other by the comparison, i.e., it is determined that the version of the execution program 22a as the target of the instruction is not the latest version (S105: NO), the terminal device 2 reads the instruction information in correspondence to the execution program 22a as the target of the accepted instruction form the version table 11a included in the central device 1 with the control by the control part 20 (S106).

Subsequently, the terminal device 2 compares the accepted instruction with the instruction indicated by the instruction information read from the version table 11a with the control by the control part 20 to determine whether or not the instructions match each other (S107). When the accepted instruction and the read instruction are different from each other in the step S107, the instruction is not the target of the monitoring, and it is determined that the execution of the instruction is possible without updating the execution program 22a. When the accepted instruction and the read instruction match each other, the instruction is the target of the monitoring, and it is determined that the update of the execution program 22a is necessary.

When it is determined that the instructions are different from each other by the comparison in the step S107 (S107: NO), the terminal device 2 returns to the step S101 with the control by the control part 20 to repeat the subsequent processing.

When it is determined that the instructions match each other by the comparison in the step S107 (S107: YES), the terminal device 2 reads the urgency degree information in correspondence to the execution program 22a as the target of the accepted instruction from the version table 11a included in the central device 1 with the control by the control part 20 (S108), and determines whether or not the urgency degree indicated by the read urgency degree information is “1” indicating that the update is forcibly performed with the highest priority (S109).

When it is determined that the urgency degree indicates the forcible update in the step S109 (S109: YES), the terminal device 2 downloads the information for update 11c in correspondence to the execution program 22a recorded in the central device 1 with the control by the control part 20 (S110), updates the execution program 22a to the new version on the basis of the downloaded information for update 11c (S111), and returns to the step S101 to repeat the subsequent processing. In the step S110, the information for update 11c recorded in the device and/or the position indicated by the position information recorded in the record is downloaded. When processing such as a reboot of the terminal device 2 or the like is required after the update of the version of the execution program 22a in the step S111, the required processing is executed. When the processing such as the reboot or the like is not required, the accepted instruction is executed in the execution program 22a after the update.

When it is determined that the urgency degree does not indicate the forcible update in the step S109 (S109: NO), the terminal device 2 outputs the request for the input of the instruction indicative of approval or disapproval of the update from the output part 26 with the control by the control part 20 (S112). In the step S112, a message of “Do you update the program to the new version? (YES/NO)” is outputted from the output part 26 as, e.g., a monitor, and the user is requested to determine whether or not the update is executed and input the result of the determination. Subsequently, the user inputs approval/disapproval information indicative of approval or disapproval of the update.

The terminal device 2 accepts the input of the approval/disapproval information from the input part 25 with the control by the control part 20 (S113) and determines whether the accepted approval/disapproval information indicates approval or disapproval of the update (S114).

When it is determined that the update is approved in the step S114 (S114: YES), the terminal device 2 advances to the step S110 with the control by the control part 20 to execute the subsequent processing.

When it is determined that the update is disapproved in the step S114 (S114: NO), the terminal device 2 executes the accepted instruction with the control by the control part 20 and, thereafter, returns to the step S101 to repeat the subsequent processing.

The case where the urgency degree does not indicate the forcible update in the step S109 is the case where the urgency degree information is “2” or “3”. When the urgency degree information is “2” and it is determined that the update is disapproved in the step S114, after a termination instruction to the execution program 22a is detected, the update of the execution program 22a is forcibly executed.

When it is determined that the execution of the instruction is disapproved in the step S103 (S103: NO), the terminal device 2 outputs information indicative of disapproval of the execution of the instruction from the output part 26 with the control by the control part 20 and returns to the step S101 without executing the accepted instruction to repeat the subsequent processing.

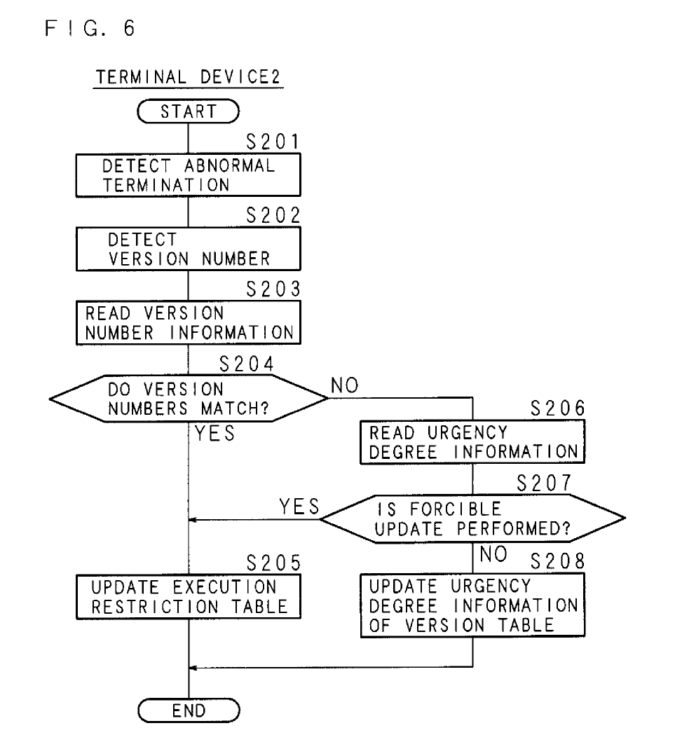

FIG. 6 is a flow chart illustrating an example of processing at the time of an abnormal termination of the terminal device 2 used in the update system of the invention. When the operating system 22b detects the abnormal termination of the execution program 22a under execution in the terminal device 2, the computer program 2a of the invention resident in the operating system 22b detects the abnormal termination of the execution program 22a from the operating system 22b. The terminal device 2 detects the abnormal termination of the execution program 22a with the control by the control part 20 executing the computer program 2a of the invention (S201), and detects the version number of the version of the abnormally terminated execution program 22a (S202).

Subsequently, the terminal device 2 accesses the central device 1 connected to the communication network 100 through the communication part 24 with the control by the control part 20 and reads the version number information in correspondence to the abnormally terminated execution program 22a from the version table 11a included in the central device 1 (S203). Then, the terminal device 2 compares the version number of the version of the abnormally terminated execution program 22a with the version number of the version indicated by the version number information read from the version table 11a with the control by the control part 20 to determine whether or not the version numbers match each other (S204).

When it is determined that the version numbers match each other by the comparison in the step S204, i.e., it is determined that the version of the execution program 22a as the target of the instruction is the latest version (S204: YES), the terminal device 2 updates the recorded content of the execution restriction table 11b with the control by the control part 20 (S205), and ends the processing at the time of the abnormal termination. That is, although the version is the latest version, it is determined that a restriction needs to be newly provided on the execution program 22a because of its possible abnormal termination, and the update processing is performed in the step S205. The processing in the step S205 denotes processing of writing new information in association with the program information in order to prohibit the execution of the execution program 22a. In particular, when the instruction having causing the abnormal termination is identified, new information is written in association with the program information and the instruction information. When the abnormal termination occurs, the execution by other users may be prohibited by immediately setting prohibition of the execution in the restriction information or, after only addition of a new record is performed and the restriction information is set to indicate that the monitoring is not performed, a person in charge of the system may newly set the recorded content of the execution restriction table 11b after his or her analysis.

When it is determined that the version numbers are different from each other by the comparison in the step S204, i.e., it is determined that the version of the execution program 22a as the target of the instruction is not the latest version (S204: NO), the terminal device 2 reads the urgency degree information in correspondence to the abnormally terminated execution program 22a from the version table 11a included in the central device 1 with the control by the control part 20 (S206), and determines whether or not the urgency degree indicated by the read urgency degree information is “1” denoting that the update is forcibly performed with the highest priority (S207).

When it is determined that the urgency degree denotes the forcible update in the step S207 (S207: YES), the terminal device 2 advances to the step S205 with the control by the control part 20 to execute the subsequent processing, and ends the processing at the time of the abnormal termination.

When it is determined that the urgency degree does not denote the forcible update in the step S207 (S207: NO), the terminal device 2 updates the urgency degree information in correspondence to the abnormally terminated execution program 22a in the version table 11a to “1” denoting that the update is forcibly performed with the highest priority with the control by the control part 20 (S208), and ends the processing at the time of the abnormal termination. That is, it is determined that there is a possibility of the abnormal termination unless the version of the execution program 22a is updated to the latest version, and a setting is performed such that the forcible update is performed at the time of the next execution of the execution program 22a.

Thus, in the update system of the invention, it is possible to perform the processing of monitoring the update of the version of the execution program and restricting the execution of the execution program in the state where the update is not performed. In addition, an enforcement level of the update may be adjusted for each instruction. As a result, it is possible to perform flexible monitoring in accordance with the situation. For example, even among a plurality of instructions given to the same execution program, the execution of an instruction concerning an inquiry about a report, printing, or the like is approved without the update, and the prohibition of the execution or the forcible update is performed for an instruction concerning an input of new data, the update thereof or the like.

The embodiment is only illustrative of part of numerous forms of the invention, and the invention may be developed into various forms other than the embodiment. For example, the monitoring may be performed only on a per execution program basis instead of performing the monitoring on a per instruction basis, and the version table may be provided in the terminal device.

Further, it is possible to develop the invention into various forms in which, for example, various update information may be preliminarily downloaded at the time of the boot of the terminal device and, when it is determined that the update is necessary, the update may be executed on the basis of the downloaded update information, and the like.

Furthermore, it is possible to develop the invention into various forms in which, for example, by setting the computer program of the invention so as to be activated using a BIOS program, the computer program may manage the version of the operating system as the execution program, and the like.

In the embodiments, the update on the basis of a determination of whether or not the update of an execution program is necessary and the result of the determination is automatically performed every time an instruction to the execution program is accepted. Therefore, the necessity for an extra work required for monitoring of the latest version and the update is obviated. With this arrangement, only a necessary update may be performed on the basis of a detected execution program and a detected instruction, and the execution of the instruction in a state where the update is not performed may be prevented.

In the embodiments, when the instruction to the execution program is accepted, the update of the execution program is performed on the basis of a determination of whether or not the execution program as the target of the instruction is to be updated and the result of the determination. With this arrangement, the necessity for the extra work required for the monitoring of the latest version of the execution program and the update of the execution program may be obviated. In addition, the determination of whether or not the execution program is to be updated is performed on the basis of a recorded content of a version table. With this arrangement, versions of a plurality of the execution programs may be managed by merely managing the recorded content of the version table without individually paying attention to the respective execution programs provided in the terminal devices.

In the embodiments, because program information, version number information, and instruction information are managed in association with each other in the version table, the update of only the part in correspondence to the instruction to be executed may be performed. Therefore, increases in communication load and processing load and a burden on a storage area resulting from an unnecessary update may be prevented and efficient version management may be performed.

In the embodiments, at the time of activation of the execution program and/or execution of a given instruction, a necessary update of the execution program may be executed, and the efficient version management may be performed.

In the embodiments, in the version table, the program information, the version number information, and urgency degree information are managed in association with each other and, with regard to the update of the execution program with a low urgency degree, the acceptance of an instruction indicative of approval or disapproval of the update is requested. With this arrangement, the execution of the instruction may be given higher priority than the update of the execution program. In contrast, with regard to the update of the execution program with the high urgency degree, the update is forcibly performed without accepting the instruction indicative of approval or disapproval of the update. With this arrangement, the occurrence of failures resulting from the omission of the update may be prevented.

In the embodiments, when the execution program is abnormally terminated, the urgency degree of the update is enhanced. With this arrangement, the successive occurrence of the abnormal termination resulting from the omission of the update may be prevented.

In the embodiments, an execution restriction table recording therein condition information indicative of the version number and/or time is provided. With this arrangement, various restrictions such as the restriction on the execution by the execution program with the old version number, the restriction on the execution of the execution program when a manager is absent, and the like are performed. With this arrangement, effects of the efficient version management, the prevention of the occurrence and exacerbation of the failures, and the prevention of unnecessary restriction on the execution may be expected to be obtained.

In the embodiments, when the update system is applied to a server/client system using central devices and the terminal devices, only one version table of one central device is managed. With this arrangement, the versions of the execution programs of a plurality of terminal devices having respective different execution programs and executing respective different instructions may be managed.

The update system, the program execution device, and the computer program according to the aspects of the embodiment detects the instruction accepted for the execution program such as an application program or the like, determines whether or not the update of the execution program is necessary before the execution program executes the detected instruction, and updates the execution program when it is determined that the update of the execution program is necessary.

With this configuration, since the determination of whether or not the update is necessary and the update are automatically performed every time the instruction to the execution program is accepted in the embodiment, the excellent effect is achieved that the necessity for the extra work required for the monitoring of the latest version and the update is obviated, only the necessary update may be performed on the basis of the detected execution program and instruction, and the execution of the instruction in the state where the update is not performed may be prevented.

More specifically, there is provided in, e.g., the central device the version table recording therein the program information indicative of the execution program, the version number information indicative of the version number of the version of the updatable execution program, the instruction information indicative of the instruction to the execution program, and the urgency degree information indicative of the urgency degree in association with one another. In, e.g., each of the terminal devices connected to the central device via a communication network such as, e.g., a LAN or the like, the instruction accepted for the execution program is detected, the version number of the version of the execution program as the target of the instruction is detected, the version number information in correspondence to the execution program as the target of the accepted instruction is read from the version table, and the execution program is updated when it is determined that the version number of the version of the detected execution program and the version number of the version read from the version table are different from each other.

With this configuration, in the embodiment, the determination of whether or not the update is necessary is performed on the basis of the recorded content of the version table so that versions of a plurality of the execution programs may be managed by merely managing the recorded content of the version table without paying attention to the execution programs provided in the individual terminal devices. Particularly, by managing only the version table in the central device, the versions of the execution programs of a plurality of terminal devices having respective different execution programs and executing respective different instructions may be managed only by managing the version table in one central device. That is, the excellent effect is achieved that the management of the version of the execution program may be efficiently implemented with a small workload.

In addition, with this configuration, since the version number is examined for each of the instructions such as the activation of the execution program, the execution of a given instruction, and the like and the update of only the part in correspondence to the instruction to be executed may be performed, the excellent effect is achieved that increases in communication load and processing load and burden on the storage area resulting from an unnecessary update are prevented and the efficient version management may be performed.

Further, the update system and the like according to the aspects of the embodiment achieve the excellent effect that it is determined whether or not the acceptance of the instruction indicative of approval or disapproval of the update is necessary in accordance with the urgency degree indicated by the urgency degree information recorded in the version table, the execution of the instruction may be preferably given higher priority than the update by requesting the acceptance of the instruction indicative of approval or disapproval of the update with regard to the update with the low urgency degree, and the occurrence of the failures resulting from the omission of the update may be preferably prevented by obviating the acceptance of the instruction indicative of approval or disapproval of the update and forcibly performing the update with regard to the update with the high urgency degree. Furthermore, the update system and the like according to the aspects of the embodiment achieve the excellent effect that, by enhancing the urgency degree when the execution program is abnormally terminated, successive occurrence of the abnormal termination resulting from the omission of update may be prevented.

Moreover, in the update system and the like according to the aspects of the embodiment, there is provided the execution restriction table recording therein the condition information indicative of the version number and/or the time as the condition for the execution of the instruction in association with the program information, and it is determined whether or not the execution of the instruction is approved on the basis of the condition for the execution program as the target of the accepted instruction by referring to the execution restriction table.

With this configuration, in the embodiment, various restrictions such as the restriction on the execution by the execution program with the old version number, the restriction on the execution of the execution program when the manager is absent, and the like are preferably performed, and the excellent effect is achieved that the effects of the efficient version management, the prevention of occurrence and exacerbation of the failures, and the prevention of unnecessary restriction on the execution may be expected to be obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the invention has(have) been described in detail, it should be understood that the various changes, substitutions, and alterations could be made hereto without departing from the spirit and scope of the invention.

What is claimed is:

1. An update system for updating an execution program capable of executing an accepted instruction, comprising:
a part detecting the instruction accepted for the execution program;
a part determining whether or not an update of the execution program is necessary, before the execution program executes the detected instruction; and
a part updating the execution program when it is determined that the update of the execution program is necessary.

2. An update system for updating an execution program capable of executing an accepted instruction, comprising:
a version table recording version number information indicative of a version number of a version of an updatable execution program in association with program information indicative of the execution program;
an instruction detection part detecting the instruction accepted for the execution program;
a detection part detecting the version number of the version of the execution program as a target of the accepted instruction when the instruction detecting part detects the instruction;
a read part reading the version number information in correspondence to the execution program as the target of the accepted instruction from the version table;
a comparison part comparing the detected version number of the version with the version number of the version read from the version table; and
an update part updating the execution program when it is determined that the version numbers are different from each other by the comparison.

3. The update system of claim 2, wherein
the version table is configured to record instruction information indicative of the instruction in association with the program information, and
the read part is configured to read the version number information associated with the accepted instruction and the execution program as the target of the instruction.

4. The update system of claim 3, wherein
the version table is configured to record the instruction information indicative of an activation instruction to the execution program and/or the instruction information indicative of a given operation instruction to an activated execution program.

5. The update system of claim 2, wherein
the version table is configured to record urgency degree information indicative of an urgency degree in association with the program information, and
the update part is configured to determine whether or not an acceptance of an instruction indicative of approval or disapproval of the update is necessary in accordance with the urgency degree indicated by the urgency degree information in correspondence to the program information of the execution program as the target of the update.

6. The update system of claim 3, wherein
the version table is configured to record urgency degree information indicative of an urgency degree in association with the program information, and
the update part is configured to determine whether or not an acceptance of an instruction indicative of approval or disapproval of the update is necessary in accordance with the urgency degree indicated by the urgency degree information in correspondence to the program information of the execution program as the target of the update.

7. The update system of claim 4, wherein
the version table is configured to record urgency degree information indicative of an urgency degree in association with the program information, and
the update part is configured to determine whether or not an acceptance of an instruction indicative of approval or disapproval of the update is necessary in accordance with the urgency degree indicated by the urgency degree information in correspondence to the program information of the execution program as the target of the update.

8. The update system of claim 5, further comprising:
a part detecting an abnormal termination of the execution program; and
a part modifying the urgency degree information recorded in the version table in association with the program information indicative of the execution program from which the abnormal termination is detected.

9. The update system of claim 6, further comprising:
a part detecting an abnormal termination of the execution program; and
a part modifying the urgency degree information recorded in the version table in association with the program information indicative of the execution program from which the abnormal termination is detected.

10. The update system of claim 7, further comprising:
a part detecting an abnormal termination of the execution program; and
a part modifying the urgency degree information recorded in the version table in association with the program information indicative of the execution program from which the abnormal termination is detected.

11. The update system of claim 2, further comprising:
an execution restriction table recording condition information indicative of the version number and/or time as a condition for the execution of the instruction in association with the program information; and
a part determining whether the execution of the instruction is approved or disapproved on a basis of the condition for the execution program as the target of the accepted instruction by referring to the execution restriction table.

12. The update system of claim 2, further comprising:
a terminal device having the execution program, the instruction detection part, the detection part, the read part, the comparison part, and the update part; and
a central device having the version table.

13. A program execution device for updating an execution program capable of executing an accepted instruction, comprising:
a part detecting the instruction accepted for the execution program;
a part determining whether or not an update of the execution program is necessary before the execution program executes the detected instruction; and
a part updating the execution program when it is determined that the update of the execution program is necessary.

14. A computer-readable recording medium which stores a computer-executable program means for causing a computer having an execution program capable of executing an accepted instruction to update the execution program, the computer-executable program means causing the computer to execute:
detecting the instruction accepted for the execution program;
determining whether or not an update of the execution program is necessary before the execution program executes the detected instruction; and
updating the execution program when it is determined that the update of the execution program is necessary.
